(19) United States
(12) Patent Application Publication
(10) Pub. No.: US 2008/0011825 A1
(43) Pub. Date: Jan. 17, 2008

(54) TRANSACTIONS USING HANDHELD ELECTRONIC DEVICES BASED ON UNOBTRUSIVE PROVISIONING OF THE DEVICES

(76) Inventors: Claeton J. Giordano, Menlo Park, CA (US); Donald G. Green, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/457,120

(22) Filed: Jul. 12, 2006

(51) Int. Cl. G06K 5/00; G06K 15/00

(52) U.S. Cl. 235/380; 235/383

(57) ABSTRACT

A system and method enabling consumers to settle payments using a handheld electronic device. The handheld electronic device preferably is provisioned with a unique code in a manner that does not require specialized software or hardware. A reader receives the unique code from the handheld electronic device, determines a consumer ID, and transmits the consumer ID, a reader ID and a payment amount to a service center. The service center retrieves the consumer account and the merchant account based on the consumer ID and the reader ID, and settles the payment by transmitting the accounts and the payment amount to a payment processing network.

### FIELD OF THE INVENTION

The present invention relates generally to transactions using handheld electronic devices, for example using mobile phones as payment instruments. More specifically, the present invention relates to the use of handheld electronic devices in a manner where the provisioning of these devices for these transactions can be accomplished in a relatively unobtrusive manner.

### BACKGROUND

Mobile phones and other handheld electronic devices are becoming ubiquitous and are also rapidly becoming more powerful and functional. Many users carry their mobile phones more frequently and to more places than their wallets or car keys. Because mobile phones are becoming an inseparable part of daily life, there is an increasing interest in expanding the functionality of mobile phones beyond just phone calls. For example, there is some interest in enabling mobile phones to make payments or to facilitate other types of transactions.

One attempt to use mobile phones as payment instruments requires customers to establish and maintain a new account into which they transfer funds from their bank account or credit card account. The mobile phone effectively becomes a sort of prepaid cash card. One drawback is that this approach typically requires a separate dedicated account, meaning that the customer must take the initiative to open a new account and then must manage one more account. Also, because the new account typically is funded by the customer's existing accounts, he may have to pay a higher interest rate if the account is funded by transfer from a credit card account or accept a lower return if the new account is funded from a savings account. More accounts generally results in higher transaction costs, whether it be in the form of higher interest, lower returns or added fees.

Another approach requires the use of a mobile phone specially designed for use in payment transactions. While this approach may provide users with features specifically designed to make payments, it greatly limits consumers' choices in mobile phones. This is especially problematic considering that many customers use their mobile phones as personal digital assistants (PDA), game consoles, MP3 players, cameras or other purposes. Requiring customers to use certain types of mobile phones forces them to forego the wider variety of mobile phones that might otherwise meet their specific needs. In addition, customers must purchase a new phone if their current phone is not one of the specially designed phones.

In a related approach, rather than requiring customers to use specific types of mobile phones, existing mobile phones are provisioned to support payment transactions by adding special technology (hardware and/or software) on an “after market” basis. While this approach avoids some of the drawbacks of the previous two approaches, it also inherits some of the drawbacks from both of the previous two approaches. Requiring the addition of special technology often means that the customer must take the initiative to have the technology added (or at least agree to its addition). In some cases, such as with specialized hardware, the customer will have to take the extra step of either adding the hardware himself (with all of the attendant problems) or making a special trip to a service center where the hardware can be added. In addition, the issue of compatibility almost always means that not all types of mobile phones will be supported, thus limiting the customer's choice. It is even possible that, as new updates of the specialized technology are released, a phone that was compatible with an earlier version may lose compatibility with the newer version and thus lose its payment transaction capability.

More generally than just payment transactions, a majority of the mobile phones currently on the market have some kind of network accessing capability, enabling mobile users universal access to the wireless Internet. The mobile network technologies are maturing rapidly and the deployed connection speeds are approaching those of DSL. The relevant mobile data services standards are also mature and have broad industry support. However, acquiring and manipulating content using mobile phones is still very inconvenient. This is partly because both the display and the input method of the mobile phone are restricted by its size, causing interactive Internet access using the mobile phone to be inefficient.

Therefore, there is a need for convenient and unobtrusive approaches to allow consumers to use mobile phones in payment transactions. More generally, there is a need to allow users of all sorts of handheld electronic devices to perform different transactions, including payment transactions and accessing and manipulating content or other relevant information.

### SUMMARY

In certain embodiments of the present invention, consumers can use handheld electronic devices to settle payment transactions. The handheld electronic device is provisioned (preferably in an unobtrusive manner) with a unique code that is associated with the consumer's account that will be used to settle the payment transaction (e.g., a credit card account or bank account). For convenience, this account will be referred to as a payment account. The unique code preferably is not native to the handheld electronic device (e.g., it is not the serial number of the handheld electronic device). As a result, the need for physical access to the device and/or cooperation of device manufacturers is eliminated. A reader acquires the unique code from the handheld electronic device. The reader transmits a corresponding consumer ID based on the unique code and payment transaction data to a remote service center to authenticate the consumer and settle the payment.

In one embodiment, payments are settled using the Automated Clearing House (ACH) network using mobile phones. As part of the registration process, the mobile phone handset is provisioned by downloading a barcode (or data that can be used to generate a barcode) to the handset. Many handsets are capable of accepting this type of data so provisioning typically is unobtrusive and does not require the addition of specialized software or hardware. Furthermore, if the consumer's payment account in question is a pre-existing one, the inconvenience of establishing a new account can also be avoided. At the point of sale, the consumer displays the barcode on his handset and presents the handset to a reader. The reader optically reads the barcode, optionally acquires a PIN from the consumer, and acquires a transaction amount for the sale. The reader determines a consumer identifier (consumer ID) based on the barcode and transmits the consumer ID, optionally the PIN, the transaction amount and optionally also a reader identifier (reader ID) to a remotely located service center. The service center validates the consumer account identified by the consumer ID, optionally authenticates the identity of the consumer by the PIN, and retrieves a merchant account associated with the reader ID. If this is done successfully, the service center begins settlement of the payment transaction by submitting the identity of the accounts and the payment transaction data to the ACH network. The service center may transmit a confirmation to the reader and/or the mobile phone.

One advantage is that certain embodiments provide consumers with convenient payment methods. Certain embodiments are designed to work with existing mobile phones and existing consumer accounts. They do not require a hardware modification or application download. They also do not require the opening of a new account. Furthermore, consumers can enroll in the payment service easily at many different locations. Once the service is activated, consumers can use their mobile phones like a PIN-protected debit card.

Another advantage of certain embodiments is security. Consumers need both the mobile phone handset and the PIN in order to make a payment. Therefore, an unauthorized person cannot use the mobile phone alone to make payments. Also, in this particular example, the unique code is optically acquired from the mobile phone handset by the reader, a mechanism which is not easily intercepted like a Bluetooth transmission. To further secure the payment system, communications between the reader and the remote service center can be secured. Furthermore, because the consumer's account information is stored at the remote service center, it is not accessible by merchants and is not transmitted between the merchant and service center. This reduces the risk of unauthorized use or disclosure of this sensitive information.

Still another advantage of embodiments that utilize the ACH network is that the ACH network has lower transaction costs compare to other payment processing networks such as credit card payment processing networks. The merchants also receive other benefits, including shorter check out times, lower fraud rates, and in some cases, an increase in sales.

The invention is not tied to just payments. For example, in another aspect of the invention, relevant content is transmitted to a user's mobile phone or other handheld electronic device upon the user's request. The user presents the unique code on his handheld electronic device to a reader. The reader transmits a corresponding user ID and reader ID to the remote service center. The service center determines content based on the user ID and reader ID, which provide information about the general context of the request. For example, the service center may retrieve a reader profile (e.g., this reader is located in a mall) and/or a user profile (e.g., this user likes sports) and return content based on the profiles (e.g., a list of sporting goods shops located in the mall).

Various advantages of this aspect are that various embodiments can determine a user's context and intention, retrieve relevant information based on the user's demand and/or push such information to the user. Another advantage is that certain embodiments deliver relevant information to the handheld electronic device without the need for bilateral relationships between users and merchants. Users do not need to sign up with each merchant or acquire merchant information to receive that merchant's content, and merchants do not need to sign up each user and acquire user information in order to deliver their content. When a new user joins the network, they have access to existing merchants and vice versa.

In another aspect of the invention, the payment and relevant content aspects are integrated to provide a system for the delivery of messages containing promotional incentives that are later automatically redeemed at the time of payment. Acquisition of the incentive is user-initiated, either at a device located within a merchant's store or elsewhere. The incentive can be activated, for example, via interaction with a web page (promotional) message, or via an SMS message, or by email sent from a handheld device or network connected computer. One advantage to this approach is that the user need not carry anything or recall any information to be supplied at the time of purchase in order to redeem the incentive. Examples of incentives include discounts, free products and the accrual of points. Another advantage is that the redemption of the incentive is integrated into the payment, enabling automatic application of the incentive to the purchase.

Another advantage is that the mechanism associates a specific presentation of an incentive to the user with a specific store visit and purchase. This enables measurement of the effectiveness of the medium for the presentation of that specific incentive and enables pay-per-action pricing of the medium. For example, an online advertisement might include a place for the user to enter their mobile phone number or instructions to send a number to the service center's SMS shortcode via SMS. The service center would record that a specific user had seen a specific ad and optionally be eligible for a specific promotional offer. A reader in a store could later retrieve this information. The user could receive the promotional discount, and the ad publisher could demonstrate that a specific ad resulted in a specific user's store visit and purchase, motivating premium pricing for that ad.

These features are not the only advantages of the invention, nor will every embodiment necessarily contain all of these features or advantages. In view of the drawings, specification, and claims, many additional features and advantages will be apparent.

### BRIEF DESCRIPTION OF THE DRAWINGS

FIG. 1 is a block diagram illustrating an architecture for one embodiment of the present invention.

FIG. 2 is a flowchart illustrating one embodiment of a registration process in accordance with the invention.

FIG. 3 is a flowchart illustrating one embodiment of a payment transaction process in accordance with the invention.

FIG. 4 is a flowchart illustrating one embodiment of a relevant content delivery process in accordance with the invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

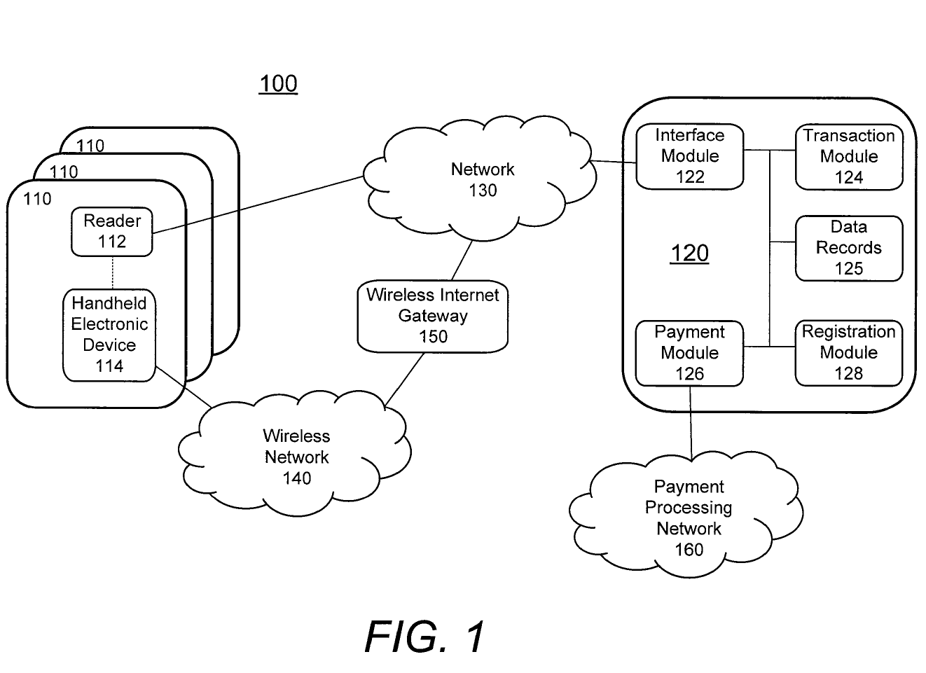

Preferred embodiments of the present invention are now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey various principles of the invention to those skilled in the art. For example, much of the discussion with respect to FIGS. 1-3 focuses on an embodiment that uses barcodes on mobile phones to enable payment transactions on the ACH network. None of these aspects is required and other embodiments may not use barcodes, or mobile phone, or payment transactions, or the ACH network.

FIG. 1 shows a block diagram illustrating the architecture of a payment system 100 in accordance with an embodiment of the invention. The payment system 100 includes a service center 120, multiple readers 112 and handheld electronic devices 114. In this example, each reader 112 is located in a merchant location 110. The readers 112 are connected to the remotely located service center 120 through a network 130 (e.g., the Internet). The devices 114 are connected to the service center 120 through a wireless network 140, which in this case is connected to the service center 120 via a wireless gateway 150 and the network 130.

The service center 120 includes an interface module 122, a transaction module 124, a payment module 126, and a registration module 128, that can communicate with each other. The interface module 122 also communicates over the network 130 to the readers 112 and over the wireless network 140 (via the network 130 and wireless gateway 150) to the devices 114. The payment module 126 communicates with one or more payment processing networks 160.

Considering each of the components in turn, the handheld electronic device 114 is a physical device with wireless or cellular access capability. Examples of the device 114 include mobile phones, wireless enabled personal digital assistants (PDA) and other portable wireless handheld data devices. Further examples include Palmtop computers, handheld GPS navigation devices, iPods, handheld music players, and handheld picture and video players (some have wifi or gprs or other data services). In cases where the device does not have wireless capability, other communications media (such as the wired Internet) can be used. In the example of FIG. 1, the device 114 is equipped and configured to be able to access the wireless network 140 and to save data received from the wireless network 140.

The handheld electronic device 114 is used to present a unique code that is then acquired by the reader 112. The unique code can be an image that is displayed by the device 114, for example on a screen of the device. Two examples of images are barcodes and alphanumeric strings. For security, the images preferably are copyrighted such that digital rights management features on the device will prevent forwarding it to another device. The image can be in color or in black and white. The image need not be visible to humans. For example, it can be an infrared image that is not perceivable by humans. Alternatively, the unique code can be an audible sound, for example a ring tone. Similar to visual images, audible sounds need not be detectable by humans.

The reader 112 is a physical device with network access capability. The reader 112 is configured to include sensors designed to detect the unique code presented by the handheld electronic device 114. Examples of such sensors include barcode scanners, imaging systems, character recognition systems and microphones. The reader 112 preferably also includes a device that allows additional input of data. In this way, the user can input a PIN or other authentication data.

In this particular example, each reader 112 is deployed in a merchant location 110. The merchant location 110 is a venue where consumers may want to make payments. Examples of the merchant location 110 include movie theaters, amusement parks, paid parking garages, and retail stores. Examples of readers 112 include point-of-sale devices and kiosks.

The network 130 may be a wired or wireless network. Examples of the network 130 include the Internet, an intranet, or a combination thereof. The wireless network 140 typically is a network different from the network 130. Examples of the wireless network 140 include a Global System for Mobile communication network (also called GSM network), a Code Division Multiple Access network, a Time Division Multiple Access network, a General Packet Radio Service network, a Wideband Code Division Multiple Access network, a Time Division Synchronous Code Division Multiple Access network, a Universal Mobile Telephone System, or a combination thereof. In this example, the network 130 and the wireless network 140 are connected by a wireless gateway 150, although this is not required.

Referring now to the service center, first note that although each “module” 122-128 is shown in FIG. 1 as a single box, this is for convenience and is not meant to imply that a module must be implemented as a single device, in a single location, or separately from the other modules. The term “module” is used here generically to refer to any combination of computing and/or communications capability. Modules can be implemented as appliances, servers, software, distributed systems, and other combinations of hardware and/or software, to name a few examples.

The interface module 122 is the front end to the other modules and functions as a communication gateway into the service center 120. The interface module 122 can be implemented in many different ways. One example is a corporation virtual private network front end. It can also contain multiple components and even networks. For example, one set of components within the interface module 122 may interface to network 130 and readers 112, and a separate set of components within the interface module 122 may interface to wireless network 140 and devices 114. These two sets of components may be physically separate and may not even communicate with each other.

Furthermore, although the communication channels to the readers 112 and devices 114 overlap in FIG. 1 (both communication paths utilize network 130), this is also not required. For example, the service center 120 may communicate with the readers 112 through a dedicated private network and communicate with the handheld electronic devices 114 through a completely separate public wireless network. Nor is it required that the same communications channel be used to communicate to all readers 112 or to all handheld electronic devices 114. For example, a proprietary interface module 122 may be used to communicate with readers 112 on a proprietary network and a web server 112 to communicate with readers 112 on the Internet.

The transaction module 124 is the engine that processes the transactions. It typically has access to various data records 125, for example consumer profiles and merchant profiles. A consumer profile typically includes information such as the consumer's name, mobile phone number, consumer identifier (consumer ID), bank account information (e.g., bank name, routing number, account number), personal identification number (PIN), and the like. The consumer profile can also store information such as whether the consumer is in good standing, which can be determined by the consumer's payment history. The transaction module 124 can create, modify, and delete consumer profiles as transactions occur and based on consumers' requests. The consumer profiles can be stored in a database 125 and indexed by the user ID and the mobile phone number. The transaction module 124 preferably can also retrieve a consumer profile from the database based on a user ID.

The transaction module 124 also manages merchant profiles. Similar to a customer profile, a merchant profile typically includes information such as the merchant's name, merchant identifier (merchant ID), bank account information, and the like. The merchant profiles can be stored in the database 125 together with the customer profiles. The transaction module 124 can create, modify, delete merchant profiles, and retrieve a merchant profile from the database based on a merchant ID.

The transaction module 124 also receives and services requests from the other modules. For example, the interface module 120 receives requests for payment transactions and passes these to the transaction module, which then accesses the relevant records 125 and processes the requests.

The payment module 126 settles payment transactions between consumers and merchants. It provides the interface to the payment processing network(s) 160. The payment module 126 can support one or multiple different payment processing networks 160. In one embodiment, the payment module 126 interfaces to the Automated Clearing House (ACH) network. Debit card networks and credit card networks are examples of other payment processing networks 160 that might be supported by the payment module 126.

The registration module 128 is used for initial enrollment of consumer and merchants and provisioning of the consumers' handheld electronic devices 114.

The service center 120 can be configured on one or more conventional computing systems having a processor, memory, storage, network interfaces, peripherals, and applicable operating system and other functional software (e.g., network drivers, communication protocols, etc.). In addition, the modules 122-128 are logically configured to function together and can be configured to reside on one physical system or across multiple physical systems. One skilled in the art will recognize that the system architecture illustrated in FIG. 1 is merely exemplary, and that the invention may be practiced and implemented using many other architectures and environments.

In one specific embodiment discussed in further detail below, the payment system 100 uses barcodes on mobile phones to enable payment transactions on the ACH network. In this embodiment, the handheld electronic device 114 is a mobile phone handset and the reader 112 is a point-of-sale device installed at a retail location for example at the checkout of a grocery store. The unique code is a barcode displayed on the screen of the mobile phone handset and optically read by the reader 112. The reader 112 is connected via a wireless network router to the network 130, and contains a microprocessor, wireless internet card, barcode reader, and a ¼ VGA touch screen. The mobile phone 114 is connected to the service center 120 via its normal wireless network connection 140. The payment processing network 160 is the ACH network.

One advantage of using barcodes and mobile phones is their ubiquity and ease of use. Mobile phones are carried almost everywhere and thus will be readily available for use at checkouts. Barcodes can be unobtrusively downloaded to mobile phones and easily displayed on the mobile phone screen at checkout. Barcodes are also familiar to consumers so no lengthy adaptation period is required.

One advantage to using the ACH network to settle payment transactions is low cost. The cost of using ACH network to settle payments is much lower compared to the cost of using other payment processing networks. For example, the cost of settling a payment transaction over a credit card payment processing network averages approximately 2.5% of the total transaction cost plus a flat fee ranging from 15 to 30 cents per transaction, while an ACH transaction typically costs somewhere between 2.5 and 25 cents. By using the ACH network, the payment system 100 can reduces retailer transaction costs by 50%.

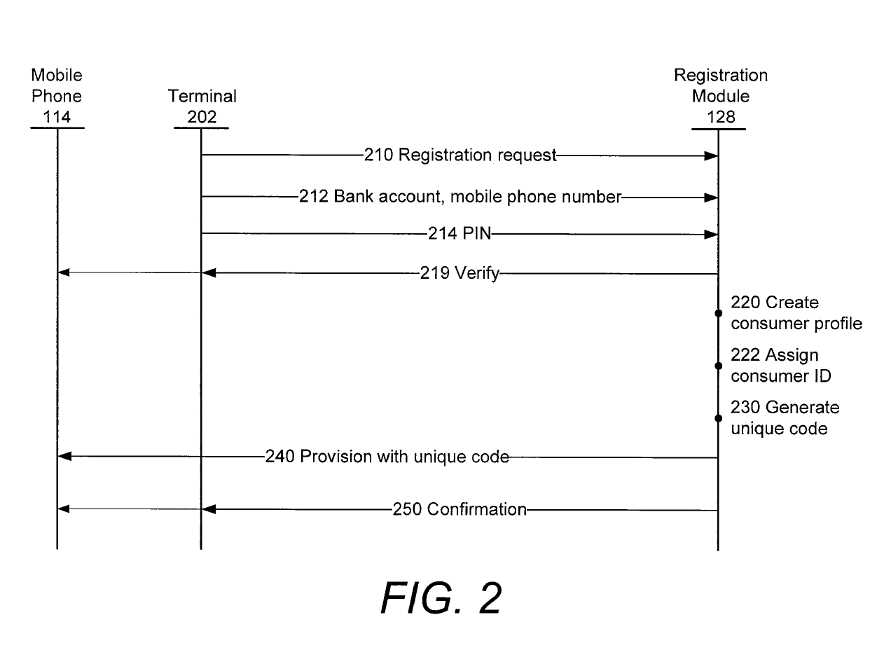

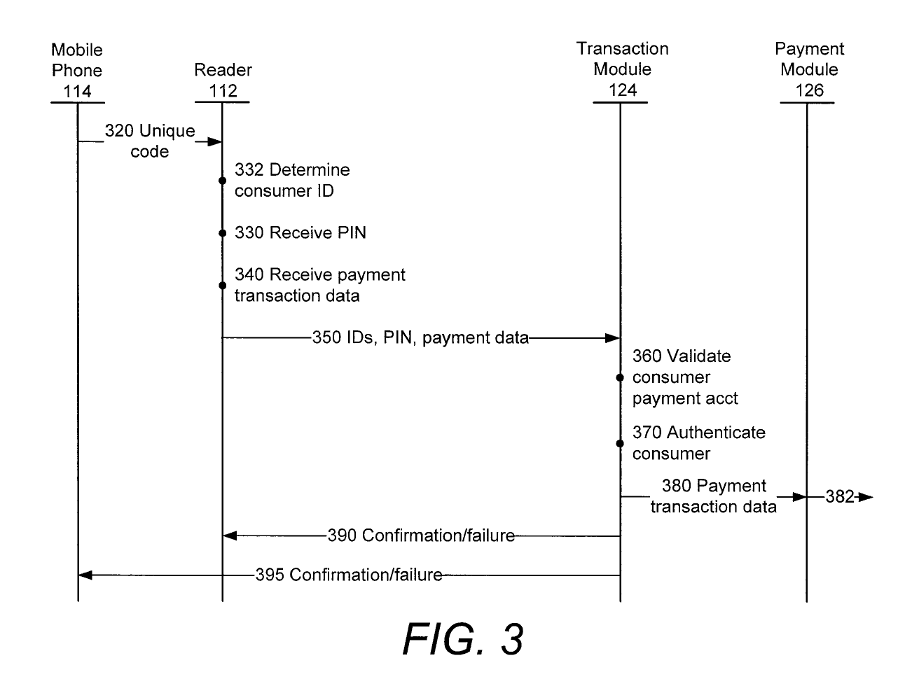

FIGS. 2-3 illustrate operation of the payment system 100 using this specific example. The operation can be divided into two parts: a registration process and a transaction process. During the registration process (FIG. 2), the consumer registers for the payment service and his mobile phone(s) are provisioned to make payments. The consumer typically also creates a profile for the payment system 100. During the transaction process, the consumer uses his provisioned device 114 to settle one or more payment transactions.

FIG. 2 shows a flow diagram depicting a registration process. In this example, the registration process is initiated by the consumer. The consumer uses a terminal 202 to send 210 a registration request to the registration module 128 through the Internet and the interface module 122. As part of the registration process, the consumer also provides 212 information about the consumer's identity (e.g., name, home address), the consumer's payment account (e.g., bank name, routing number, and account number if it is a bank account, credit card number and expiration date if it is a credit card account), the device 114 (e.g., phone number if the device 114 is a mobile phone, internet protocol address if it is a network enabled PDA). Note that the registration process establishes an account for the consumer with the service center. This account, which will be referred to as the service center account, typically will not be the same as the consumer's payment account.

The consumer also selects 214 a PIN. The PIN is designed to allow subsequent authentication of the consumer. Examples include a multiple-digit number or an alphanumeric string. The PIN provides additional security to the payment system 100. Because unauthorized parties do not know the PIN, they cannot make a payment using the consumer's payment account even if they have access to the device 114.

The terminal 202 can be any conventional computing systems with user input device (e.g., keyboard), network interfaces, and applicable operating system and other functional software (e.g., network drivers, communication protocols, encryption software, etc.). The consumer can send 210-214 the request and related information by using a web browser to visit a web site hosted by the interface module 122. The consumer can also use email to send information to the registration module 128. Alternatively, the consumer can do so by using an application designed for the registration process, in which case the necessary application can be encoded as hardware in the terminal 202. The terminal 202 can be located in a merchant location 110 or elsewhere. In other embodiments, the consumer can choose to provide 210-214 relevant information over the phone or via other conventional communication channels (e.g., the postal system) to the service center 120. In order to keep the consumer's information confidential, sensitive information preferably is encrypted before sending 210-214 to the service center 120.

In some embodiments, the registration module 128 verifies 219 the provided consumer information. For example, the registration module 128 may verify the provided mobile phone number by sending a confirmation SMS message containing a confirmation code to the mobile phone. The consumer is required to send the confirmation code back to the service center 120 in order to be verified. Alternately, the registration module 128 may confirm with the payment processing networks 160 that the consumer's payment account is a valid account and that the consumer is the account holder.

The registration module 128 creates 220 a consumer profile for the consumer and stores the received consumer information in the consumer profile within database 125. The registration module 128 also assigns 222 a consumer ID to the consumer. The consumer ID may be newly generated or may be an existing identifier (e.g., the consumer's social security number or some account number).

The registration module 128 generates 230 a unique code for the consumer profile. The unique code is associated with the consumer ID and the corresponding consumer accounts, so that a reader 112 can determine the associated consumer ID from the unique code. The relationship between the consumer ID and the unique code can be secretive or apparent. In some cases, the unique code can be the same as the consumer ID or a derivative of the consumer ID. The unique code can be an image (e.g., a barcode image), a string (e.g., the consumer ID in binary format), a sound sequence (e.g., a ring tone), or any other format that the device 114 can make available to the reader 112.

The registration module 128 then provisions 240 the device 114 with the unique code. This can be done in a number of different ways. For mobile phones 114, the module 128 may download the unique code to the mobile phone via the wireless network 140 using existing data services. Alternately, if the unique code is the same as the consumer ID or a variation of the consumer ID, the registration module 128 might provision the device 114 by transferring the consumer ID to the device 114.

More generally, rather than transferring the actual unique code, the registration module 128 may provision the device by transferring data that can be used to generate the unique code. This data will be referred to as digital code data. For example, the digital code data might be a seed that is used to generate the unique code, or that is combined with other data (such as the time of day) to generate the unique code. The unique code may change over time, as would be the case when it is generated based on some combination of digital code data and the time of day. Alternately, the unique code may expire periodically or after each use. This would increase the security of the payment system 100. Different types of coding, compression, hashing and encryption can be used to relate digital code data with the actual unique code used for any particular transaction.

Provisioning 240 preferably occurs without requiring the alteration of software or hardware on the device 114. One example would be the download of data that can be used to generate the unique code by using only the device's native functionality. One advantage is that this makes the unique code more portable and possible to restore should it be deleted or inadvertently modified. If the consumer changes his mobile phone, it is simpler to provision the new phone and to deactivate the old phone. For example, if the unique code is a barcode, then provisioning the new phone merely requires the download of the barcode to the new phone since the barcodes is not a native part of phones. In contrast, if the unique code was the manufacturer's serial number, which is a native attribute of a phone, then provisioning a new phone would be more complicated since the native attribute of the new phone would have to be associated with the consumer's account credentials. This would require communication of the new phone's native attribute to some registry and some form of authentication and authorization such that only the consumer could initiate use of the new phone's native attribute, in order to prevent malicious changing of the consumer's authorized phone.

In contrast, provisioning the phone based on the non-native unique code decouples the phone from the authentication scheme by relying on possession of the unique code as opposed to possession of the phone. The phone is a means for carrying the unique code, much like a wallet is a means for carrying a magnetic stripe card. In contrast, if a native attribute of the phone (such as a manufacturer's serial number or a payload bound to some native characteristic of the phone) is used instead, then the phone itself becomes part of the authentication scheme and is subject to the necessary security constraints when changing a factor instance of an n-factor authentication scheme.

Using a non-native unique code has many advantages. For example, the form, bit depth, and size of namespace for a non-native unique code is neither fixed nor controlled by the phone manufacturer. As a result, the unique ID format can be upgraded without changing the device. In addition, different and appropriate representations of the unique code can be used on different devices. As another advantage, use of a native attribute means that the native attribute must be reliably acquired by a central authority in order to associate it with the consumer's account or identity. In contrast, provisioning a non-native unique code allows the central authority make the association and then send the unique code to the consumer's phone. As another difference, if a native attribute is somehow compromised (e.g. duplicated on another phone or associated with the account of the phone's prior owner not in good standing), it effectively cannot be replaced or otherwise modified. In contrast, an existing non-native unique code can simply be replaced with a new and different one using the same provisioning process that established the original unique code. Provisioning also allows the issuer to use unique codes that are uniform across all phone manufactures. In contrast, a native attribute cannot be controlled by the issuer and may not be uniform across all manufacturers.

In some embodiments, the registration module 128 may optionally send an application to the handheld electronic device 114. The consumer can install the application (or it may auto-install) and use it to generate the unique code from digital code data received from the service center 120 and stored in the device 114.

Upon completion of steps 210-240, the registration module 128 may optionally send 250 a confirmation to the terminal 202 through the Internet, indicating that the registration process is completed and the consumer can start using the payment system 100 through the device 114. If any of the steps 210-240 fails, the registration module 128 may notify the consumer that the registration process failed.

FIG. 3 shows a flow diagram depicting a transaction process. In this example, a consumer with a provisioned mobile phone 114 would like to make a purchase from a merchant that has a reader 112 at the point of sale. The consumer makes the payment transaction using payment system 100 rather than his credit card, cash, check or other means.

The consumer uses the device 114 to present the unique code, which is acquired 320 by the reader 112. In this example, the unique code is a barcode image. The consumer displays the barcode on the mobile phone and waves the mobile phone under the reader 112. The reader 112 optically reads the barcode. If the unique code were a ringtone, the device 114 would play the ring tone to the reader 112. The reader 112 hears the ringtone through its audio sensors (e.g., microphone). The reader 112 determines 322 the consumer ID corresponding to the unique code. In some cases, the consumer ID is the same as the unique code. The consumer is prompted for his PIN, which he enters at a keypad. The reader 112 receives 330 the entered PIN.

The reader 112 also receives 340 the payment transaction data. This payment transaction data includes a payment amount, and optionally includes descriptions of the products or services paid for by the transaction. The payment transaction data can be transmitted to the reader 112 from an electronic point of sale system. The reader 112 may confirm the payment transaction data with the consumer before submitting it to the service center 120.

The reader 112 sends 350 its reader ID, the consumer ID, the payment transaction data, and the PIN (or other consumer authentication data) to the transaction module 124 through the network 130 and the interface module 122. Because this transmitted data is sensitive information, communications between the reader 112 and service center 120 preferably occur over a secure communications channel. For example, the reader 112 can encrypt the data before sending 350 it to the transaction module 124.

The transaction module 124 validates 360 a consumer payment account identified by the consumer ID, confirming for example that the account is still valid and the payment amount is not over the account limit. The transaction module 124 may also determine the consumer's standing based on the consumer's past payment transactions and make appropriate responses.

Transaction module 124 also authenticates 370 the consumer based on the received PIN. The module 124 compares the received PIN with the PIN stored in the consumer profile identified by the consumer ID. If the two PINs match, the consumer is authenticated.

Similarly, the transaction module 126 can validate the reader ID and merchant account.

Subject to proper validation 360 of the consumer account and authentication 370 of the consumer (and validation of the merchant account if that step is also taken), the transaction module 124 provides 380 the relevant payment transaction data (e.g., consumer account, merchant account, payment amount) to the payment module 126. The payment module 126 settles the payment transaction by submitting 382 the consumer account, the merchant account, and the payment amount to the payment processing network 160.

After the payment module 126 receives a confirmation that the payment transaction is authorized from the payment processing network 160, the transaction module 124 sends 390 a confirmation to the reader 112. The reader 112 sends a transaction-approval message to the point of sale, which finishes the payment transaction by printing a receipt for the consumer. If the transaction is not authorized by the payment processing network 160, the transaction module 124 sends a negative response to the reader 112.

The transaction module 124 can also send 395 a separate confirmation to the handheld electronic device 114 via the wireless network 140, for example a text message to the mobile phone stating that the transaction has been approved. Optionally, the transaction module 124 can also store the payment transaction data in database 125, and can then provide the payment transaction history to the consumer upon demand.

In one implementation, the payment processing network 160 is the ACH network. In this case, each transaction results in an ACH entry that includes the consumer account, the merchant account, and the payment amount. The ACH entries are aggregated. Periodically, a batch processing request is sent to the ACH network for debiting consumer accounts and crediting merchant accounts. The service center may also debit the merchant account (or consumer account, depending on who pays the transaction fee) and credit its own account for the transaction fee. The ACH entries are sent over the ACH network to an Originating Depository Financial Institution (ODFI), who can be any financial institution who does ACH origination. The ODFI deducts the payment amount from the consumer account, and sends the ACH entry to an ACH Operator (usually the Federal Reserve) and is passed on to a Receiving Depository Financial Institution (RDFI), where the merchant account is issued a credit of the payment amount.

FIGS. 2-3 are based on an example in which system 100 uses barcodes on mobile phones to enable payment transactions, for example on the ACH network. The system 100 is not limited to this example and can be used for many other purposes. The system 100 can also be configured to provide relevant information and content to handheld electronic devices 140 upon the users' request.

Similar to the mobile phone based payment system described above, overall operation can typically be divided into a registration process and a transaction process. The details of implementation of the processes will depend on the specific application. The registration process can be similar as described above except, for example, users may not provide their payment account information and PIN if payments are not being made.

In a generic transaction process, assuming the unique code is a barcode image, the user displays the barcode on the device 114 and presents it to the barcode reader 112. The reader 112 determines the user ID (i.e., analogous to the consumer ID except that the user may not be a consumer) from the barcode and transmits the user ID and the reader ID to the service center 120. The service center 120 might retrieve the corresponding user profile and reader profile. The reader profile typically will either expressly or implicitly provide information about the user's location and intention, based on the location and other facts about the reader. For example, if the reader location is known, then the approximate location of the user is also known. The user profile may include information about the user's preferences. The service center 120 determines relevant content based on the user ID and reader ID and pushes the content to the device 114. The content provided can be static or a mobile web application page with which the user can interact via the device 114.

For example, a user waves his mobile phone 114 with barcode in front of a kiosk 112 located by the entrance to a theater. The service center 120 determines that the user probably intend to receive some information about movies shown on that theater, and pushes information about the five movies starting in the next 15 minutes at that particular theater to the mobile phone. If the reader 112 also implemented payment capability, the user could select a movie and authorize payment for the movie tickets using the mobile phone.

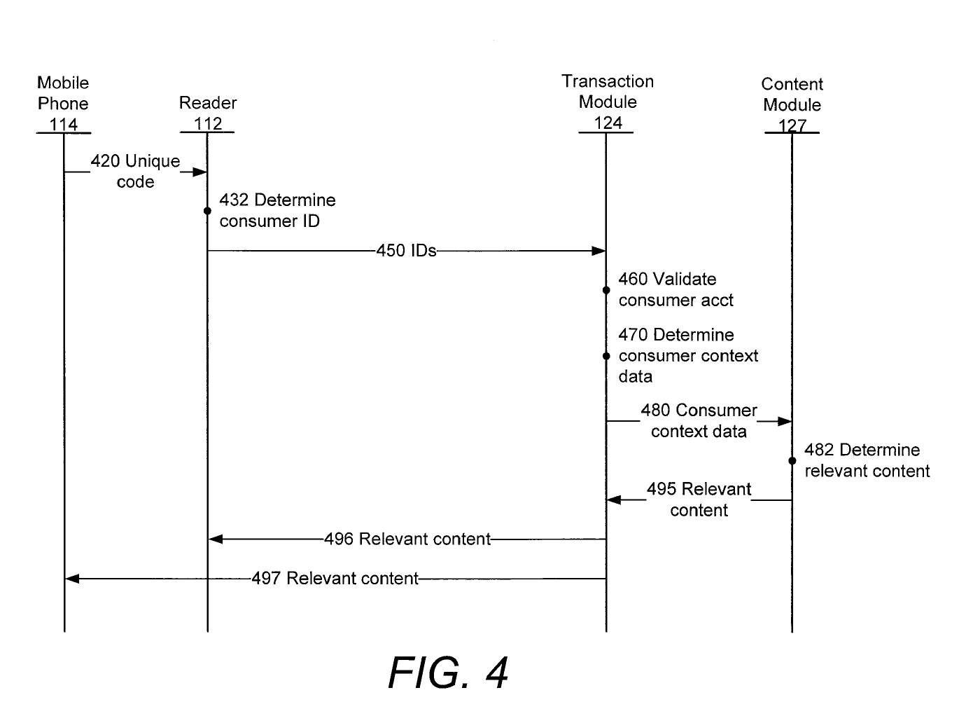

FIG. 4 is a flowchart illustrating one embodiment of a relevant content delivery process in accordance with the invention. In this example, a consumer with a provisioned mobile phone 114 would like to obtain “relevant” content based on his current context. The consumer receives the content using a modified version of system 100. In the modified version, the payment module 126 is not required if no payments are being made. An additional content module 127 (not shown in FIG. 1) is used to determine the relevant content.

The consumer uses the device 114 to present the unique code, which is acquired 420 by the reader 112. The reader 112 determines 422 the consumer ID corresponding to the unique code. In some cases, the consumer ID is the same as the unique code. The reader 112 sends 450 its reader ID and the consumer ID to the transaction module 124 through the network 130 and the interface module 122. Because this transmitted data is sensitive information, communications between the reader 112 and service center 120 preferably occur over a secure communications channel. For example, the reader 112 can encrypt the data before sending 450 it to the transaction module 124.

The transaction module 124 validates 460 a consumer account identified by the consumer ID. In this case, the relevant consumer account may be the consumer's account with the service center, rather than an independent payment account. The transaction module 124 determines 470 consumer context data based on the consumer account and the reader ID. For example, the reader ID may provide information about the consumer's locality (e.g., facing the entrance to a movie theater) and/or intention (e.g., would like to see a movie). The consumer account may provide information about the consumer's preferences (e.g., prefers R-rated action movies over G-rated animation), which may be entered directly by the consumer or determined indirectly by analysis of the consumer's past behavior, for example.

Subject to proper validation 460 of the consumer account, the transaction module 124 provides 480 the relevant consumer context data (which may be just the reader ID and consumer ID) to the content module 127. The content module 127 determines 482 the relevant content (e.g., a listing of movies that will start in the next 30 minutes, with the R-rated action movies listed before the G-rated animation). This content is sent 495 back to the transaction module, for further transmission to 496, 497 to the reader 112 and/or device 114 for display to the consumer. Note that the content may be transmitted between devices by sending tags, pointers or other identifiers, rather than sending the actual content itself.

Additional transactions may occur. For example, the consumer may purchase tickets to one of the listed movies (e.g., using the process of FIG. 3). Alternately, the consumer may select a follow-up action, such as requesting a list of other movie theaters within 30 minutes driving (if the consumer does not like any of the listed movies) or a list of restaurants in the local vicinity (if the consumer has decided to eat dinner first).

Note that the transaction module 124 and content module 127 can be implemented in a distributed fashion by multiple entities and/or interact with other modules or databases operated by other entities. Consider an example where the consumer is in a grocery store and readers are located at different points in the grocery store. The service center may be able to determine only that a specific reader is part of the grocer's account but may not be able to determine the exact location within the grocery store. Instead, the transaction module 124 might send the reader ID to an outside database (e.g., the grocer's backend system), which returns the product displayed at that location as being Tropicana Juice. Similarly, the service center may not have complete profile information for the consumer. Instead, the transaction module 124 might send the consumer ID (or some other identification for the consumer) to a third party, such as a merchant POS data warehouse, which returns the consumer's relevant purchase history. The content module 127 uses this information to decide to send a marketing promotional message with a discount for the Calcium Fortified version of Tropicana Juice (women in 50's who has prior purchases of calcium supplements) or for the 12-Pack of 12 oz pkgs for lunches (women in 30's with purchasing history of competing Ocean Spray and JuiceBox lunch drink products for children).

Once a unique consumer ID has been established for a consumer via the provisioning process and the establishment of an account with the service center, a large number of transactions can be enabled. These include various types of payment; implementation and management of loyalty programs; in-store and out-of-store messaging; promotions; print, broadcast, and internet advertising; and the tracking of a consumer's purchase activity across stores. This approach to mobile identity can be used to bring together the various elements of the customer experience by establishing a single identity for each consumer (based on the consumer ID and unique code), thus reducing their ID requirements for a broad range of services to just their phone (or, more generally, to just their handheld electronic device).

The same consumer ID can also be used for transactions using other devices, for example purchases made over the Internet from a wired desktop computer. Alternately, devices can be provisioned with the unique code using a communications media other than wireless or cellular access. As one example, iPods can be provisioned with the unique code when they are synced with a computer connected to the Internet.

All of the information associated with a particular consumer ID, be it payment credentials, loyalty status, purchase history, or demographic information, can be stored on servers at the service center and is associated with a given consumer via their mobile phone. When a customer swipes their phone, information about the location and purpose of that device comes together with information about that customer to perform a payment transaction, a coupon redemption, an information push, a update of the person's profile and/or all the above.

Loyalty programs are one example. Loyalty programs are established by merchants primarily to help them identify and reward their best customers. Existing programs suffer from a number of problems, including the difficulty of registering the customer, the requirement that the customer carry a program specific identity in the form of a card or a key fob, and the inefficiency of capturing and recording separate payment and loyalty information from the customer. Though all customers must pay, because of these problems, a much lower percentage of customers participate in loyalty programs.

The approach described above can solve these problems by using the phone for both payment and loyalty. Customers who sign up for a loyalty program do not need to carry anything additional to enjoy the benefits of loyalty participation. When the customer presents his phone for payment, the service center is able to determine that he is a member of that merchant's loyalty program and his account is automatically adjusted to reflect the current purchase. If he is eligible for a reward, that information can be presented on the payment terminal and the customer can decide whether or not he wants to redeem it. In any case, the customer automatically accrues benefits that he is entitled to based upon the current purchase. Typically, this will be done when the consumer pays for the purchases using the mobile phone and unique code, but this is not required. There may be situations where the service center tracks a consumer's loyalty status, though he uses a different payment option. Signing up for additional loyalty programs becomes simple, because the customer need only swipe his phone across a reader at the new merchant, and he can be asked if he wants to join the program. This can be configured such that the consumer is only asked the first time. Alternately, he can be asked more times.

A merchant's existing loyalty program can be implemented on the platform described above. Alternately, a new loyalty program can be established. Additionally, because the same “token” (phone) is used across all merchants, cross-store programs or general purpose (e.g. point system) loyalty programs can also be implemented. Because the “token” has wireless connectivity, more advanced functions, such as notification to the consumer of his current loyalty status, or one time or limited time member only offers can be automatically transmitted to the consumer in real time.

For merchants, advantages include greater loyalty participation; automatic, real-time tracking of program status; and more accurate information. For consumers, it is easier to participate in the programs and therefore easier to garner the rewards.

Out of store promotion/messaging can also be supported by this platform. Merchants can use a range of promotions, including coupons and direct mail. These programs are established to increase store visits and increase the dollars spent during a given visit. The redemption rate of coupons and direct mail promotions are typically low because of poor targeting, the lack of differentiation between programs, and the difficulties in redemption. For example, a consumer who is mailed a coupon must notice it in a sea of like solicitations, they must be interested in what is offered, and they must remember to bring the coupon to the store to redeem it.

The approach described above can solve these problems by sending notice of the promotion directly to a consumer's phone via SMS or MMS. Then, when the phone is used for payment, the redemption is automatic. This can be achieved by noting in the service center database that this person is entitled to a given benefit. A message describing the benefit and conditions (locations, time limits, etc) is sent to the customer. When the customer comes into the store and purchases the advertised item (for example), he automatically receives the benefit.

Using this capability, merchants can target down to the individual customer level. Because this is a new channel for consumers, they are more likely to notice it. In addition, because they do not need to do anything to enjoy the benefits (no coupon clipping, no carrying something extra with them, etc), they are more likely to redeem the benefit.

For merchants, this means more targeted, lower cost programs with higher conversion rates. It also means that the time between program conception and an increase in customers coming into the store is reduced. (i.e. it tightens up the promotion loop at a lower cost). For consumers, they get more promotions that they are interested in, the consumers are always “carrying” the promotions with them, redemption is automatic and they enjoy the promotion benefits.

A variation of this type of program is that the promotion could be initiated by the manufactures that supply to the merchants rather than by the merchants themselves. So, for example, a manufacture of soft drinks could send a two for one promotion to a number of consumers in a given area, which they could redeem if they buy the soda within a set number of days at a given merchant. This would drive a large number of customers into that merchant's store.

In store promotion/messaging can also be supported. Similar to the out of store promotions described above, if a consumer presents his phone to a reader in the store prior to check out, promotions based upon his profile can be sent to him while he is still in the store. These can be restricted to use during a very limited time (e.g. while the customer is still in the store) and they can be automatically redeemed upon check out. The customer gets the benefit of the promotion. The merchant gets a larger dollar sale and improves the customer experience.

Business intelligence can also be supported. Many merchants and consumer goods manufactures spend significant time and money to sort through their inventory, payment and loyalty data to better understand who is buying what, when and why. Historically, this related date is gleaned from separate sources resulting in a fragmented and incomplete picture of the consumers' behavior. For example, from POS data, merchants typically know what items are selling and when, but they do not know to whom. Similarly, from loyalty data, merchants might know customer spending levels, but not what those dollars were spent on. In addition, it is nearly impossible for a merchant to determine what the consumers' spending habits are outside of the merchant's own sales to the consumer.

However, because consumers who use the system described above can have a single unique identity across merchants and transaction types (purchases, loyalty, etc), a more holistic view of a given consumer and his behavior can be constructed. Though this data will typically only be shared on an aggregate basis, it will be of higher value in that it will incorporate purchase and loyalty information, response rates to promotions, and advertisements across a wider set of customer transactions. For example, it would be possible for a grocer to learn that a large number of his customers who do not buy meat in fact buy it at a competitor's, and that a significant number of them are responsive to print advertising but not broadcast advertising.

This platform can also be used to “close the loop” on print, broadcast, and internet advertising. For example, a print ad could have a promotion code associated with it (e.g. a number printed on the ad) which the customer sends to the service center via SMS (or they could e-mail it if it is an online ad). The service center would know who it came from based upon the phone number (or the e-mail address). The service center database would store the item the consumer is interested in and the benefit that he is entitled to at that merchant based upon the advertisement. When the customer then purchases the item or service in the store, he automatically gets the benefit. This could be extended such that the consumer in fact also authorizes payment for the item or service and the merchant either sends it to the consumer, or he can pick it up but it is already paid for. It would also be possible for the consumer to forward the promotional code to someone else for them to use. This allows merchants to determine which ads are driving traffic into their stores and which are not.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A method for carrying out a payment transaction using a handheld electronic device operated by a consumer, the method comprising:
receiving a consumer ID from a remotely located reader, the consumer ID corresponding to a unique code that is acquired by the reader from the handheld electronic device, wherein the unique code is not native to the handheld electronic device;
receiving payment transaction data from the reader;
validating a consumer payment account identified by the consumer ID; and
subject to validation of the consumer payment account, submitting the payment transaction data and an identity of the consumer payment account to a payment processing network for settlement.

2. The method of claim 1, wherein the payment processing network comprises the ACH network.

3. The method of claim 1, further comprising:
receiving consumer authentication data from the reader, the consumer authentication data acquired by the reader from the consumer;
authenticating the consumer based on the consumer authentication data; and
wherein the step of submitting the payment transaction data is further subject to the authentication of the consumer.

4. The method of claim 1, further comprising:
receiving a reader ID from the reader; and
validating a merchant account identified by the reader ID; and
wherein the step of transmitting comprises, subject to validation of the consumer payment account and the merchant account, transmitting the payment transaction data, the identity of the consumer payment account and an identity of the merchant account to the payment processing network for settlement between the consumer payment account and the merchant account.

5. The method of claim 1, further comprising, before carrying out any of the other steps:
associating an existing consumer payment account with the handheld electronic device; and
provisioning the handheld electronic device with the unique code.

6. The method of claim 5 wherein the step of provisioning the handheld electronic device comprises:
transferring digital code data corresponding to the unique code to the handheld electronic device for storage on the handheld electronic device, wherein the handheld electronic device presents the unique code to the reader for acquisition based on the stored digital code data.

7. The method of claim 6, wherein the handheld electronic device is provisioned with the unique code by transferring the digital code data to the handheld electronic device and without altering software or hardware of the handheld electronic device.

8. The method of claim 6, wherein the handheld electronic device comprises a mobile phone handset and the mobile phone handset is provisioned with the unique code by downloading the digital code data over a wireless network connection to the mobile phone handset.

9. The method of claim 5 further comprising:
upon request by the consumer via a handheld electronic device, web site or phone call, re-provisioning the handheld electronic device with the unique code.

10. The method of claim 1, wherein the steps of receiving a consumer ID, payment transaction data and consumer authentication data from the reader occur over a secure communications channel.

11. The method of claim 1, wherein the unique code comprises an image and the reader optically reads the image displayed on the handheld electronic device.

12. The method of claim 1, wherein the unique code comprises a barcode and the reader optically reads the barcode displayed on the handheld electronic device.

13. The method of claim 1, wherein the unique code comprises an alphanumeric string and the reader optically reads the alphanumeric string displayed on the handheld electronic device.

14. The method of claim 1, wherein the unique code comprises an audible sound and the reader aurally acquires the audible sound generated by the handheld electronic device.

15. The method of claim 1, wherein the unique code comprises a ringtone and the reader aurally acquires the ringtone generated by the handheld electronic device.

16. The method of claim 1, wherein the reader comprises a point-of-sale device.

17. The method of claim 1, wherein the reader comprises a kiosk.

18. The method of claim 1, wherein the handheld electronic device comprises a mobile phone handset.

19. The method of claim 1, wherein the handheld electronic device comprises a portable, wireless handheld data device.

20. The method of claim 1, wherein the payment transaction data comprises a payment amount.

21. The method of claim 1, wherein the consumer authentication data comprises a PIN (personal identification number) entered by the consumer, and the step of authenticating the consumer comprises authenticating the consumer based on the entered PIN.

22. The method of claim 1, wherein the payment processing network comprises a debit card network.

23. The method of claim 1, wherein the payment processing network comprises a credit card network.

24. The method of claim 1, wherein the step of receiving payment transaction data from the reader occurs after the payment transaction data is confirmed by the reader to the consumer.

25. The method of claim 1, further comprising:
subject to successful settlement of the payment transaction data, transmitting a confirmation message to the reader; and
subject to unsuccessful settlement of the payment transaction data, transmitting a notification message to the reader.

26. The method of claim 1, further comprising:
receiving consumer authentication data from the reader, the consumer authentication data acquired by the reader from the consumer;
authenticating the consumer based on the consumer authentication data, wherein the step of submitting the payment transaction data is further subject to the authentication of the consumer; and
subject to successful authentication of the consumer, transmitting a confirmation message to the reader; and
subject to unsuccessful authentication of the consumer, transmitting a notification message to the reader.

27. The method of claim 1, further comprising:
subject to successful settlement of the payment transaction data, transmitting a confirmation message to the handheld electronic device via a communications channel different from a communications channel used to communicate with the reader; and
subject to unsuccessful settlement of the payment transaction data, transmitting a notification message to the handheld electronic device via said different communications channel.

28. The method of claim 1, wherein the handheld electronic device comprises a mobile phone handset, and the mobile phone handset is provisioned with the unique code by downloading digital code data corresponding to the unique code over a wireless network connection to the mobile phone handset without altering software or hardware of the mobile phone handset.

29. The method of claim 28, wherein the unique code comprises a barcode, and the reader optically reads the barcode displayed on the handset.

30. The method of claim 28, wherein the payment processing network comprises the ACH network, the payment transaction data comprises a payment amount, and the step of transmitting payment transaction data comprises submitting a debit transaction for the payment amount from the consumer payment account to the ACH network.

31. The method of claim 30, wherein the consumer authentication data comprises a PIN entered by the consumer, and the step of authenticating the consumer comprises authenticating the consumer based on the entered PIN.

32. The method of claim 28, wherein the payment processing network comprises a debit card and/or credit card network, the payment transaction data comprises a payment amount, and the step of transmitting payment transaction data comprises submitting a debit transaction for the payment amount from the consumer payment account to the debit card and/or credit card network.

33. A method for providing content to a handheld electronic device operated by a user, the method comprising:
receiving a user ID from a remotely located reader, the user ID corresponding to a unique code that is acquired by the reader from the handheld electronic device, wherein the unique code is not native to the handheld electronic device;
receiving a reader ID from the reader;
determining content based on the user ID and the reader ID; and
transmitting the content to the handheld electronic device and/or the reader.

34. The method of claim 33, further comprising, before carrying out any of the other steps:
transferring digital code data corresponding to the unique code to the handheld electronic device and without altering software or hardware of the handheld electronic device, the digital code data to be stored on the handheld electronic device, wherein the handheld electronic device presents the unique code to the reader for acquisition based on the stored digital code data.

35. The method of claim 34, wherein the handheld electronic device comprises a mobile phone handset and the mobile phone handset is provisioned with the unique code by downloading the digital code data over a wireless network connection to the mobile phone handset.

36. The method of claim 33, wherein the unique code comprises an image and the reader optically reads the image displayed on the handheld electronic device.

37. A method for providing relevant content to a handheld electronic device operated by a user, the method comprising:
receiving a user ID from a remotely located reader, the user ID corresponding to a unique code that is acquired by the reader from the handheld electronic device, wherein the unique code is not native to the handheld electronic device;
receiving a reader ID from the reader;
determining relevant content for a context based on the user ID and the reader ID; and
transmitting the relevant content to the handheld electronic device and/or to the reader.

38. A system for carrying out payment transactions using handheld electronic devices, comprising:
an interface module for:
receiving a consumer ID from a remotely located reader, the consumer ID corresponding to a unique code that is acquired by the reader from the handheld electronic device, wherein the unique code is not native to the handheld electronic device; and
receiving payment transaction data from the reader;
a transaction module in communication with the interface module for validating a consumer payment account identified by the consumer ID; and
a payment module in communication with the transaction module for, subject to validation of the consumer payment account, transmitting the payment transaction data and an identity of the consumer payment account to a payment processing network for settlement.

39. The system of claim 38 wherein:
the interface module is further for receiving consumer authentication data from the reader, the consumer authentication data acquired by the reader from the consumer;
the transaction module is further for authenticating the consumer based on the consumer authentication data; and
the payment module transmits the payment transaction data and an identity of the consumer payment account to a payment processing network further subject to authentication of the consumer.

40. The system of claim 38, further comprising:
a registration module in communication with the interface module, for:
associating an existing consumer payment account with the handheld electronic device; and
causing the interface module to provision the handheld electronic device with the unique code.

41. A computer program product for use in conjunction with a computer system, the computer program product comprising a computer readable storage medium and a computer program mechanism embedded therein, the computer program mechanism including:
instructions for receiving a consumer ID from a remotely located reader, the consumer ID corresponding to a unique code that is acquired by the reader from the handheld electronic device, wherein the unique code is not native to the handheld electronic device;
instructions for receiving payment transaction data from the reader;
instructions for receiving consumer authentication data from the reader, the consumer authentication data acquired by the reader from the consumer;
instructions for validating a consumer payment account identified by the consumer ID;
instructions for authenticating the consumer based on the consumer authentication data; and
instructions for, subject to validation of the consumer payment account and authentication of the consumer, transmitting the payment transaction data and an identity of the consumer payment account to a payment processing network for settlement.
